(19) United States
(12) Patent Application Publication
(10) Pub. No.: US 2014/0287624 A1
(43) Pub. Date: Sep. 25, 2014

(54) Electrical Connector

(71) Applicant: CHENG UEI PRECISION INDUSTRY CO., LTD., New Taipei City (TW)

(72) Inventors: Rong-Qin Lan, Dong-Guan City (CN); Ping-Chih Chen, New Taipei City (TW); Yin-Lung Wu, New Taipei City (TW)

(73) Assignee: Cheng Uei Precision Industry Co., Ltd., New Taipei City (TW)

(21) Appl. No.: 13/848,724

(22) Filed: Mar. 21, 2013

(51) Int. Cl. H01R 13/648

(52) U.S. Cl. CPC H01R 13/648
USPC 439/607.01

(57) ABSTRACT

An electrical connector includes an insulating body having a base portion and a tongue board, a plurality of first terminals each having a first soldering portion, a plurality of second terminals each having a second soldering portion, and a shielding shell enclosing the insulating body. A rear of a top of the base portion is concaved downward to form a groove. A bottom wall of the groove defines a plurality of first terminal grooves. The first and the second terminals are integrated in the insulating body. The first and the second terminals are arranged in two rows in vertical direction and are arranged alternately at intervals in transverse direction. The first soldering portions of the first terminals are levelly located in the first terminal grooves of the insulating body respectively and the second soldering portions of the second terminals project downward beyond a bottom face of the insulating body.

### BACKGROUND OF THE INVENTION

1. Field of the Invention

The present invention relates to a connector, and more particularly to an electrical connector.

2. The Related Art

A traditional electrical connector includes an insulating body, a plurality of terminals integrated in the insulating body respectively, and a shielding shell enclosing the insulating body therein. The terminal has a fastening strip, a contact portion and a soldering portion which are connected with two opposite ends of the fastening strip. The soldering portion is perpendicular to the fastening strip and projects downward beyond a bottom face of the insulating body for being inserted in and soldered with a printed circuit board.

However, the soldering portions of the terminals are arranged at the same direction so that results in an excessively intensive distribution for the soldering portions, and it is apt to cause solder shorts when soldering the soldering portions with the printed circuit board.

### SUMMARY OF THE INVENTION

Accordingly, an object of the present invention is to provide an electrical connector. The electrical connector includes an insulating body, a plurality of first terminals, a plurality of second terminals and a shielding shell. The insulating body has a base portion. A front of the base portion extends frontward to form a tongue board having a smaller dimension than the base portion. A rear of a top of the base portion is concaved downward to form a groove. A bottom wall of the groove defines a plurality of first terminal grooves. The first terminals each has a first fastening strip, a first contact portion and a first soldering portion which are connected with two opposite ends of the first fastening strip. The second terminals each has a second fastening strip, a second contact portion and a second soldering portion which are connected with two opposite ends of the second fastening strip. The shielding shell encloses the insulating body. The first and the second terminals are integrated in the insulating body. The first and the second terminals are arranged in two rows in vertical direction and are arranged alternately at intervals in transverse direction. The first soldering portions of the first terminals are levelly located in the first terminal grooves of the insulating body respectively and the second soldering portions of the second terminals project downward beyond a bottom face of the insulating body.

As described above, the first soldering portions of the first terminals are levelly located in the first terminal grooves of the insulating body respectively and the second soldering portions of the second terminals project downward beyond a bottom face of the insulating body. Therefore, it can effectively reduce the distribution intensity of the soldering portions of the terminals, and greatly improve soldering efficiency and soldering quality.

### BRIEF DESCRIPTION OF THE DRAWINGS

The present invention will be apparent to those skilled in the art by reading the following description thereof, with reference to the attached drawings, in which:

FIG. 1 is an assembled, perspective view of an electrical connector in accordance with an embodiment of the present invention;

FIG. 2 is an exploded, perspective view of the electrical connector shown in FIG. 1;

FIG. 3 is a perspective view of an insulating body of the electrical connector shown in FIG. 1; and

FIG. 4 is a perspective view showing that first and second terminals of the electrical connector are integrated in the insulating body.

### DETAILED DESCRIPTION OF THE EMBODIMENT

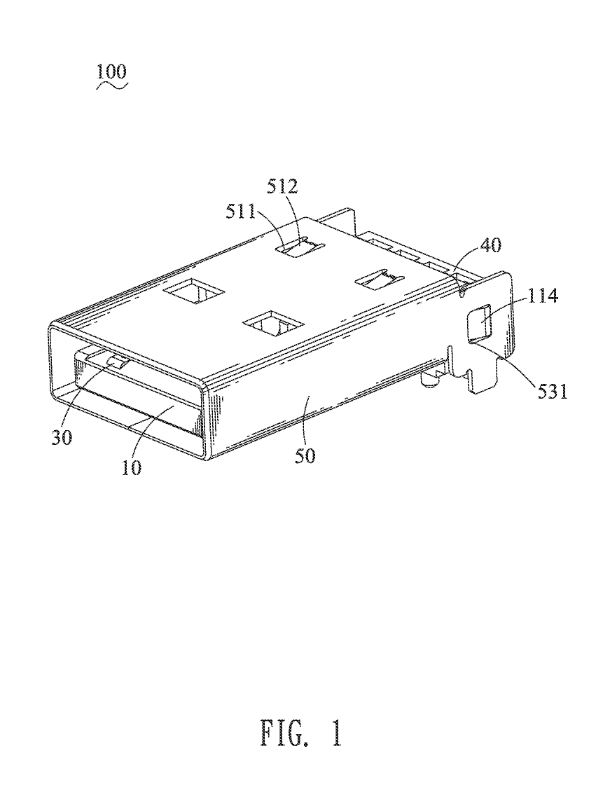

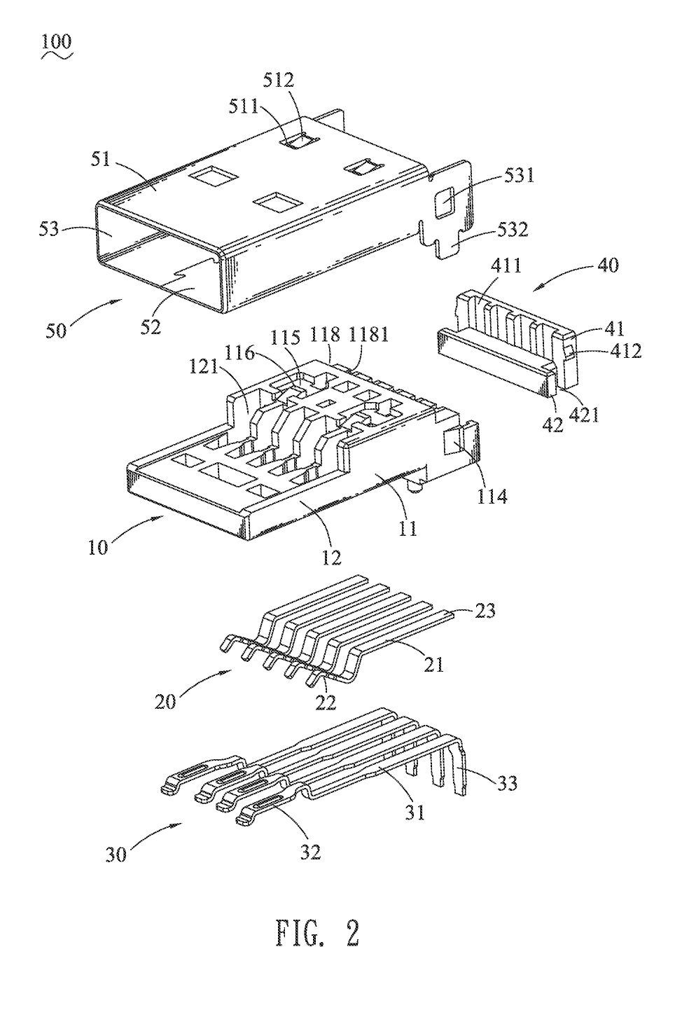

Referring to the drawings in greater detail, and first to FIGS. 1 and 2, an embodiment of the present invention is embodied in an electrical connector 100. The electrical connector 100 includes an insulating body 10, a plurality of first and second terminals 20, 30 integrated in the insulating body 10, a lid 40 being mounted to a rear of the insulating body 10 and a shielding shell 50 enclosing the insulating body 10.

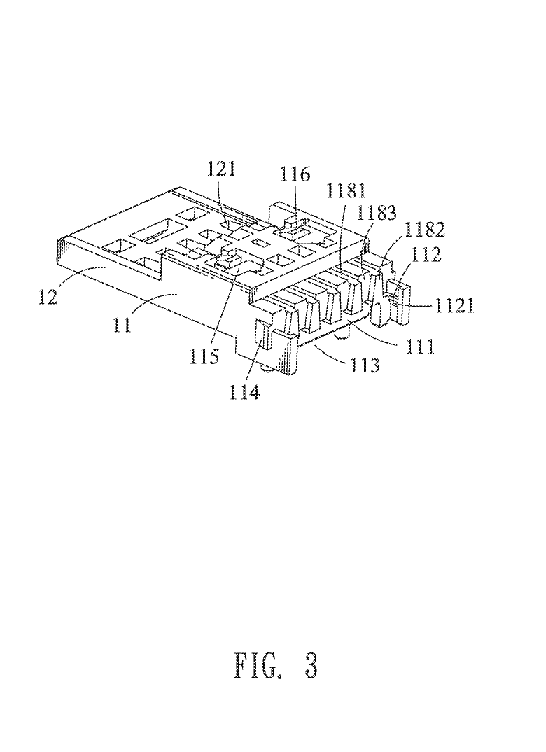

With reference to FIGS. 2 and 3, the insulating body 10 has a base portion 11. A front of the base portion 11 extends frontward to form a tongue board 12 having a smaller dimension than the base portion 11. A rear of the tongue board 12 defines a plurality of receiving grooves 121 arranged at regular intervals along the transverse direction and each penetrating vertically through the tongue board 12. The receiving grooves 121 further extend rearward to the front of the base portion 11. The base portion 11 of the insulating body 10 defines two recesses 115 at a top surface thereof and a wedge-shaped buckling block 116 is protruded upward in the front of each recess 115. A rear of a top of the base portion 11 is concaved downward to form a groove 118. A bottom wall of the groove 118 defines a plurality of first terminal grooves 1181. A rear of the base portion 11 of the insulating body 10 is concaved frontward to form a receiving cavity 111. A bottom of the receiving cavity 111 is further spread frontward to from a holding cavity 113. A front wall of the receiving cavity 111 protrudes rearward to form a plurality of positioning ribs 1182 arranged in accordance with the first terminal grooves 1181. A plurality of second terminal grooves 1183 each is defined between each two adjacent positioning ribs 1182. Two opposite insidewalls of the receiving cavity 111 protrude face-to-face to form a pair of fastening lumps 112. A bottom of the fastening lump 112 is designed with a guiding slope 1121. Two opposite insidewalls of the holding cavity 113 protrude to form a pair of vertical fastening pillars 1131. Two opposite side faces of the base portion 11 protrude outward to form a pair of locking blocks 114.

Each of the first terminals 20 has a first fastening strip 21, a first contact portion 22 and a first soldering portion 23 which are connected with two opposite ends of the first fastening strip 21. The first soldering portion 23 is levelly extended rearward from a rear end of the first fastening strip 21. The first contact portion 22 is meandered frontward from a front end of the first fastening strip 21 to substantially show an S-shape.

Each of the second terminals 30 has a second fastening strip 31, a second contact portion 32 and a second soldering portion 33 which are connected with two opposite ends of the second fastening strip 31. The second soldering portion 33 is perpendicularly extended downward from a rear end of the second fastening strip 31. The second contact portion 32 is bent upward and then extended forward from a front end of the second fastening strip 31, with a front end thereof bent downward and then extending forward.

The lid 40 has a positioning body 41 and a fastening portion 42 protruding forward from a bottom of a front face of the positioning body 41. The lid 40 defines a plurality of positioning grooves 411 arranged in accordance with the second soldering portions 33 of the second terminals 30 and each penetrating vertically through the lid 40. In this embodiment, the positioning grooves 411 are opened in the front face of the positioning body 41. Two opposite sides of the positioning body 41 oppositely protrude outward to form a pair of fastening ears 412. A pair of fastening fillisters 421 is opened at two opposite sides of the fastening portion 42.

The shielding shell 50 has a top plate 51, a bottom plate 52 and two side plates 53 which corporately define a receiving chamber (not labeled) for receiving the insulating body 10 therein. The top plate 51 defines two openings 511 at a rear thereof. A rear edge of each opening 511 extends forward and is inclined downward to form an elastic slice 512. A rear end of each side plate 53 of the shielding shell 50 defines a locking hole 531. Bottom edges of the rear ends of the side plates 53 extend downward to form a pair of soldering tails 532.

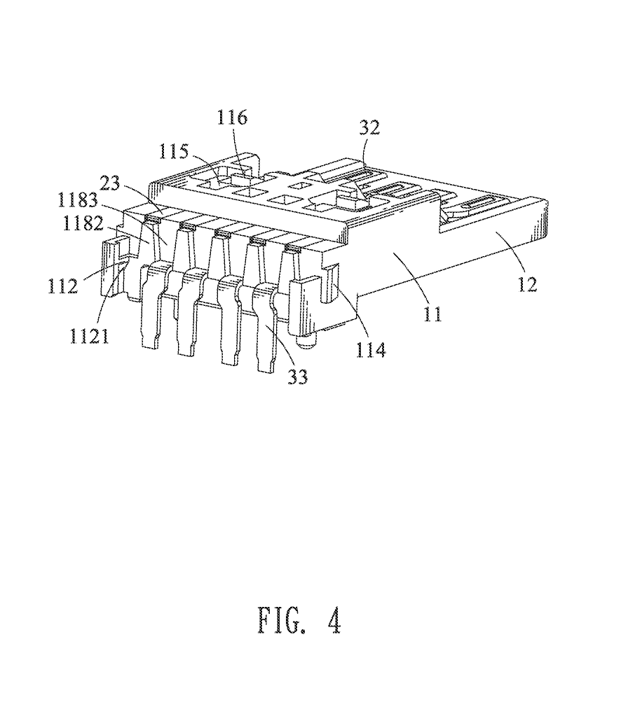

Referring to FIGS. 1, 2 and 4, the first and the second terminals 20, 30 are integrated in the insulating body 10, and are arranged in two rows in vertical direction and arranged alternately at intervals in transverse direction. In detail, the first fastening strips 21 of the first terminals 20 and the second fastening strips 31 of the second terminals 30 are molded in the base portion 11 of the insulating body 10 in the form of two rows in the vertical direction, and the rear ends of the second fastening strips 31 of the second terminals 30 are fixed in the second terminal grooves 1183 respectively. The first contact portions 22 of the first terminals 20 are located in the receiving grooves 121, and the second contact portions 32 of the second terminals 30 are exposed on the tongue board 12 and arranged in front of the first contact portions 22. The front ends of the second contact portions 32 are embedded in the tongue board 12. The first soldering portions 23 of the first terminals 20 are levelly located in the first terminal grooves 1181 of the insulating body 10 respectively and the second soldering portions 33 of the second terminals 30 project downward beyond a bottom face of the insulating body 10.

Then, the lid 40 is mounted to the rear of the base portion 11 of the insulating body 10. In detail, the positioning body 41 is inserted upward into the receiving cavity 111 and the fastening portion 42 is held in the holding cavity 113. The second soldering portions 33 of the second terminals 30 are inserted in the positioning grooves 411 of the lid 40 and tail ends thereof project under the lid 40. The fastening pillars 1131 are fastened in the fastening fillisters 421 and the fastening ears 412 slip over the guiding slope 1121 to be buckled on the top surfaces of the fastening lumps 112.

Lastly, the insulating body 10 with the first and the second terminals 20, 30 and the lid 40 are inserted frontward into the chamber of the shielding shell 50, until the elastic slices 512 are buckled in the recesses 115 of the base portion 11 and resist against rear faces of the buckling blocks 116 respectively, and the locking blocks 114 are buckled in the locking holes 531.

As described above, the first soldering portions 23 of the first terminals 20 are levelly located in the first terminal grooves 1181 of the insulating body 10 respectively and the second soldering portions 33 of the second terminals 30 project downward beyond the bottom face of the insulating body 10. Therefore, it can effectively reduce the distribution intensity of the soldering portions 23, 33 of the terminals 20, 30, and greatly improve soldering efficiency and soldering quality.

What is claimed is:

1. An electrical connector, comprising:
an insulating body having a base portion, a front of the base portion extending frontward to form a tongue board having a smaller dimension than the base portion, a rear of a top of the base portion being concaved downward to form a groove, a bottom wall of the groove defining a plurality of first terminal grooves;
a plurality of first terminals each having a first fastening strip, a first contact portion and a first soldering portion which are connected with two opposite ends of the first fastening strip;
a plurality of second terminals each having a second fastening strip, a second contact portion and a second soldering portion which are connected with two opposite ends of the second fastening strip; and
a shielding shell enclosing the insulating body;
wherein the first and the second terminals are integrated in the insulating body, the first and the second terminals are arranged in two rows in vertical direction and are arranged alternately at intervals in transverse direction, the first soldering portions of the first terminals are levelly located in the first terminal grooves of the insulating body respectively and the second soldering portions of the second terminals project downward beyond a bottom face of the insulating body.

2. The electrical connector as claimed in claim 1, further comprising a lid which is mounted to a rear of the base portion of the insulating body, the lid defines a plurality of positioning grooves arranged in accordance with the second soldering portions of the second terminals and each penetrating vertically through the lid, the second soldering portions of the second terminals are inserted in the positioning grooves of the lid and tail ends thereof project under the lid.

3. The electrical connector as claimed in claim 2, wherein the rear of the base portion of the insulating body is concaved frontward to form a receiving cavity, a bottom of the receiving cavity is further spread frontward to from a holding cavity, the lid has a positioning body and a fastening portion protruding forward from a bottom of a front face of the positioning body, the positioning grooves are opened in the front face of the positioning body, the positioning body is inserted upward into the receiving cavity and the fastening portion is held in the holding cavity.

4. The electrical connector as claimed in claim 3, wherein a front wall of the receiving cavity protrudes rearward to form a plurality of positioning ribs arranged in accordance with the first terminal grooves, a plurality of second terminal grooves each is defined between each two adjacent positioning ribs, rear ends of the second fastening strips of the second terminals are fixed in the second terminal grooves respectively.

5. The electrical connector as claimed in claim 3, wherein two opposite insidewalls of the holding cavity protrude to form a pair of vertical fastening pillars, a pair of fastening fillisters are opened at two opposite sides of the fastening portion, the fastening pillars are fastened in the fastening fillisters.

6. The electrical connector as claimed in claim 3, wherein two opposite insidewalls of the receiving cavity protrude face-to-face to form a pair of fastening lumps, a bottom of the fastening lump is designed with a guiding slope, two opposite sides of the positioning body oppositely protrude outward to form a pair of fastening ears, the fastening ears slip over the guiding slope to be buckled on the top surfaces of the fastening lumps.

7. The electrical connector as claimed in claim 1, wherein the first fastening strips of the first terminals and the second fastening strips of the second terminals are molded in the base portion of the insulating body in the form of two rows in the vertical direction, a rear end of the first fastening strip levelly extends rearward to form the first soldering portion, a rear end of the second fastening strip perpendicularly extends downward to form the second soldering portion.

8. The electrical connector as claimed in claim 1, wherein a rear of the tongue board defines a plurality of receiving grooves arranged at regular intervals along the transverse direction and each penetrating vertically through the tongue board, the receiving grooves further extend rearward to the front of the base portion, the first contact portions of the first terminals are located in the receiving grooves, the second contact portions of the second terminals are exposed on the tongue board and arranged in front of the first contact portions, front ends of the second contact portions are embedded in the tongue board.

9. The electrical connector as claimed in claim 1, wherein the base portion of the insulating body defines two recesses at a top surface thereof and a wedge-shaped buckling block is protruded upward in the front of each recess, the shielding shell has a top plate, a bottom plate and two side plates which corporately define a receiving chamber for receiving the insulating body therein, the top plate defines two openings at a rear thereof, a rear edge of each opening extends forward and is inclined downward to form an elastic slice, the elastic slices are buckled in the recesses of the base portion and resist against rear faces of the buckling blocks respectively.

10. The electrical connector as claimed in claim 9, wherein two opposite side faces of the base portion protrude outward to form a pair of locking blocks, a rear end of each side plate of the shielding shell defines a locking hole, the locking blocks are buckled in the locking holes.

11. The electrical connector as claimed in claim 9, wherein bottom edges of rear ends of the side plates extend downward to form a pair of soldering tails.
